(19) United States
(12) Patent Application Publication
(10) Pub. No.: US 2026/0158561 A1
(43) Pub. Date: Jun. 11, 2026

(54) POWER TOOL CHUCK

(71) Applicant: BLACK & DECKER INC., New Britain, CT (US)

(72) Inventors: MATTHEW STANTON, Rockville, MD (US); MATTHEW J. VELDERMAN, Baltimore, MD (US)

(21) Appl. No.: 19/181,253

(22) Filed: Apr. 16, 2025

Related U.S. Application Data
(63) Continuation of application No. 17/366,401, filed on Jul. 2, 2021, now Pat. No. 12,290,864.

(51) Int. Cl. B23B 31/173; B23B 31/16

(52) U.S. Cl. CPC B23B 31/16158; B23B 31/16045; B23B 2231/06; B23B 2231/12; B23B 2231/38; Y10T 279/17701

(57) ABSTRACT

A power tool chuck includes a chuck body, a longitudinal bore extending along an axis for receiving a tool bit, a plurality of radial slots in communication with the longitudinal bore, a plurality of jaw assemblies, each at least partially received in one of the radial slots and moveable to removably retain the tool bit in the chuck body, and a clamping ring rotatably received over the chuck body and the jaw assemblies. The clamping ring and each jaw assembly together define a first clamping interface configured to cause the jaw assembly to clamp the tool bit a first clamping force up to a first maximum clamping force during a first phase of clamping, and a second clamping interface configured to cause the jaw assembly to clamp the tool bit at a second clamping force that is greater than the first maximum clamping force during a second phase of clamping.

### RELATED APPLICATIONS

This application claims priority, under 35 U.S.C. § 120, as a continuation of U.S. patent application Ser. No. 17/366,401, filed Jul. 2, 2021, entitled “Power Tool Chuck,” which claims priority, under 35 U.S.C. § 120, as a continuation of U.S. patent application Ser. No. 16/565,575, filed Sep. 10, 2019, entitled “Power Tool Chuck,” which claims priority under 35 U.S.C. § 119(e) to U.S. Provisional Patent Application No. 62/732,029, filed Sep. 17, 2018, entitled “Power Tool Chuck”; U.S. Provisional Patent Application No. 62/732,035, filed Sep. 17, 2018, entitled “Power Tool Chuck”; U.S. Provisional Patent Application No. 62/732,222, filed Sep. 17, 2018, entitled “Chuck For Power Tool”; U.S. Provisional Patent Application No. 62/733,807, filed Sep. 20, 2018, entitled “Chuck For Power Tool”; and U.S. Provisional Patent Application No. 62/747,357, filed Oct. 18, 2018, entitled “Chuck for Power Tool”. Each of the foregoing applications is hereby incorporated by reference.

### TECHNICAL FIELD

This application relates to chucks, such as keyless chucks, for use with power tools (e.g., drills and screwdrivers).

### BACKGROUND

Chucks, including keyless chucks, for retaining tool bits in power tools, such as drills and screwdrivers, are well known in the prior art. Existing chucks tend to have issues with insufficient holding force on tool bits. These chucks also add significant overall axial length to the power tool. It is desirable to have power tool chucks that overcome these deficiencies.

### SUMMARY

In one aspect, a power tool chuck includes a chuck body extending along a chuck axis and couplable to an output spindle of a rotary power tool. A longitudinal bore is defined in the body along the axis for receiving a tool bit therein. A plurality of radial slots is defined in the body in communication with the longitudinal bore. A plurality of jaw assemblies is received in the body, each jaw assembly at least partially received in one of the plurality of radial slots and moveable to engage and removably retain the tool bit in the chuck body. A clamping ring is received over the chuck body and the jaw assemblies and rotatable relative to the chuck body and the jaw assemblies to engage and removably retain the tool bit in the chuck body. The clamping ring and each jaw assembly together define a first clamping interface configured to cause the jaw assembly to clamp the tool bit a first clamping force up to a first maximum clamping force during a first phase of clamping, and a second clamping interface configured to cause the jaw assembly to clamp the tool bit at a second clamping force that is greater than the first maximum clamping force during a second phase of clamping.

Implementations of this aspect may include one or more of the following features.

The first clamping interface may be oriented at a first angle relative to the axis and the second clamping interface is oriented at a second angle relative to the axis that is less than the first angle. The first angle may be approximately 30° to 60° and the second angle may be approximately 1° to 15°.

Each jaw assembly may comprise a first jaw portion and a second jaw portion. The first clamping interface may be defined between the first jaw portion and the clamping ring, and the second clamping interface may be defined between the first jaw portion and the second jaw portion. The first clamping interface may be oriented at a first angle relative to the axis and the second clamping interface may be oriented at a second angle relative to the axis that is less than the first angle. The first angle may be approximately 30° to 60° and the second angle may be approximately 1° to 15°.

The first clamping interface may be defined between the first jaw portion and the second jaw portion, and the second clamping interface may be defined between the first jaw portion and the clamping ring. The first clamping interface may be oriented at a first angle relative to the axis and the second clamping interface may be oriented at a second angle relative to the axis that is less than the first angle. The first angle may be approximately 30° to 60° and the second angle may be approximately 1 to 15.

The clamping ring may be threadably connected to the chuck body. An outer sleeve may be received over the clamping ring so that the outer sleeve and clamping ring rotate together. Relative rotation between the clamping ring and the chuck body may cause the jaw assembly to clamp the tool bit at the first clamping force and the second clamping force. The relative rotation between the clamping ring and the chuck body may encompass holding one of the clamping ring and the chuck body rotationally stationary while rotating the other of the clamping ring and the chuck body. The relative rotation may encompass holding the clamping ring rotationally stationary by a user grasping the outer sleeve while the chuck body rotates by actuating a motor in the power tool. The relative rotation may encompass the outer sleeve being coupled to a lock mechanism that selectively locks the outer sleeve to a housing of the power tool to inhibit rotation of the outer sleeve and the clamping ring, while the chuck body rotates by actuating a motor in the power tool. The relative rotation may encompass rotating the outer sleeve to rotate the clamping ring, while the body is held substantially stationary by a spindle lock in the power tool.

The jaw assembly may be biased away from clamping the tool bit by at least one spring. The at least one spring may comprise a first spring biasing the jaw assembly away from the chuck body in a direction substantially transverse to the axis. The at least one spring may further comprise a second spring biasing the jaw assembly in a direction substantially parallel to the axis. The jaw assembly may comprise a first jaw portion that directly engages the tool bit and a second jaw portion that directly engages the first jaw portion and the clamping ring, wherein the first spring is disposed between the body and the second jaw portion and the second spring is disposed between the first jaw portion and the second jaw portion. The first spring may comprise a compression spring and the second spring may comprise a disc spring.

The clamping ring may comprise an inner ring threadably connected to the chuck body by a first thread and an outer ring received over and threadably connected to the inner ring by a second thread. The clamping ring may further comprise a detent biased by a detent spring and coupling the inner ring to the outer ring so that the inner ring and the outer ring rotate together as a unit when a force on the detent spring is less than or equal to a spring threshold value and the outer ring rotates relative to the inner ring when the force on the detent spring exceeds the spring threshold value. The force on the detent spring may exceed the spring threshold value approximately when the second clamping force exceeds the first maximum clamping force. The first thread may have a coarser thread pitch than does the second thread. The first thread may be configured to cause the inner clamping ring to impart the first clamping force to the jaw assembly and the second thread may be configured to cause the outer clamping ring to impart the second clamping force to the jaw assembly.

In another aspect, a power tool chuck includes a chuck body extending along a chuck axis and couplable to an output spindle of a rotary power tool. A longitudinal bore is defined in the body along the axis for receiving a tool bit therein. A plurality of radial slots is defined in the body in communication with the longitudinal bore. A plurality of jaw assemblies is received in the body, each jaw assembly at least partially received in one of the plurality of radial slots and moveable to engage and removably retain the tool bit in the chuck body. A clamping ring is received over the chuck body and the jaw assemblies and rotatable relative to the chuck body and the jaw assemblies to engage and removably retain the tool bit in the chuck body. Each jaw assembly defines a first jaw portion and a second jaw portion moveable relative to the first jaw portion, and one of the first jaw portion and the second jaw portion is configured to cause the jaw assembly to clamp the tool bit at a first clamping force up to a first maximum clamping force during a first phase of clamping. The other of the first jaw portion and the second jaw portion is configured to cause the jaw assembly to clamp the tool bit at a second clamping force that is greater than the first maximum clamping force during a second phase of clamping.

Implementations of this aspect may include one or more of the following features. The jaw assembly may have a first clamping interface oriented at a first angle relative to the axis and the second clamping interface oriented at a second angle relative to the axis that is less than the first angle. The first jaw portion may directly engage the clamping ring and the second jaw portion, and the second jaw portion may directly engage the first jaw portion and the tool bit. The first clamping interface may be defined between the first jaw portion and the clamping ring and the second clamping interface may be defined between the second jaw portion and the first jaw portion. The first angle may be approximately 30° to 60° and the second angle may be approximately 1° to 15°. The first clamping interface may be defined between the first jaw portion and the second jaw portion and the second clamping interface may be defined between the first jaw portion and the clamping ring. The first angle may be approximately 30° to 60° and the second angle may be approximately 1° to 15°. The outer sleeve may be received over the clamping ring so that the outer sleeve and clamping ring rotate together. Relative rotation between the clamping ring and the chuck body may cause the jaw assembly to clamp the tool bit at the first force and the second force. The relative rotation between the clamping ring and the chuck body may encompass holding one of the clamping ring and the chuck body rotationally stationary while rotating the other of the clamping ring and the chuck body. The relative rotation may encompass holding the clamping ring rotationally stationary by a user grasping the outer sleeve while the chuck body rotates by actuating a motor in the power tool. The relative rotation may encompass the outer sleeve being coupled to a lock mechanism that selectively locks the outer sleeve to a housing of the power tool to inhibit rotation of the outer sleeve and the clamping ring, while the chuck body rotates by actuating a motor in the power tool. The relative rotation may encompass rotating the outer sleeve to rotate the clamping ring, while the body is held substantially stationary by a spindle lock in the power tool.

The jaw assembly may be biased away from clamping the tool bit by at least one spring. The at least one spring may comprise a first spring biasing the jaw assembly away from the chuck body in a direction substantially transverse to the axis. The at least one spring may further comprise a second spring biasing the jaw assembly in a direction substantially parallel to the axis. The first jaw portion may directly engage the clamping ring and the second jaw portion, the second jaw portion may directly engage the first jaw portion and the tool bit, and the first spring may be disposed between the body and the second jaw portion and the second spring may be disposed between the first jaw portion and the second jaw portion.

The clamping ring may comprise an inner ring threadably connected to the chuck body by a first thread and an outer ring received over and threadably connected to the inner ring by a second thread. The clamping ring may further comprise a spring biased detent coupling the inner ring to the outer ring so that the inner ring and the outer ring rotate together as a unit when a force on the spring is less than or equal to a spring threshold value and the outer ring rotates relative to the inner ring when the force on the spring exceeds the spring threshold value. The force on the spring may exceed the spring threshold value approximately when the second clamping force exceeds the first maximum clamping force. The first thread may have a coarser thread pitch than does the second thread. The first thread may be configured to cause the inner clamping ring to impart the first clamping force to the jaw assembly and the second thread may be configured to cause the outer clamping ring to impart the second clamping force to the jaw assembly.

In another aspect, a power tool chuck includes a chuck body extending along a chuck axis and couplable to an output spindle of a rotary power tool. A longitudinal bore is defined in the body along the axis for receiving a tool bit therein. A plurality of radial slots is defined in the body in communication with the longitudinal bore. A plurality of jaw assemblies is received in the body, each jaw assembly at least partially received in one of the plurality of radial slots and moveable to engage and removably retain the tool bit in the chuck body. A clamping ring is received over the chuck body and the jaw assemblies and rotatable relative to the chuck body and the jaw assemblies to engage and removably retain the tool bit in the chuck body. The clamping ring comprises an inner ring threadably connected to the chuck body by a first thread and an outer ring received over and threadably connected to the inner ring by a second thread. The first thread is configured to cause the jaw assembly to clamp the tool bit a first clamping force up to a first maximum clamping force when the inner ring rotates relative to the chuck body during a first phase of clamping. The second thread is configured to cause the jaw assembly to clamp the tool bit at a second clamping force that is greater than the first maximum clamping force when the outer ring rotates relative to the inner ring and the chuck body during a second phase of clamping.

Implementations of this aspect may include one or more of the following features. The clamping ring may further comprise a detent biased by a detent spring to couple the inner ring to the outer ring so that the inner ring and the outer ring rotate together as a unit when a force on the spring is less than or equal to a spring threshold value and the outer ring rotates relative to the inner ring when the force on the spring exceeds the spring threshold value. The force on the spring may exceed the spring threshold value approximately when the second clamping force exceeds the clamp threshold value. The first thread may have a coarser thread pitch than does the second thread. The first thread may be configured to cause the inner clamping ring to impart the first clamping force to the jaw assembly and the second thread may be configured to cause the outer clamping ring to impart the second clamping force to the jaw assembly.

Each jaw assembly may define a first jaw portion and a second jaw portion moveable relative to the first jaw portion, the first jaw portion configured to cause the jaw assembly to clamp the tool bit at the first clamping force, and the second jaw portion configured to cause the jaw assembly to clamp the tool bit at the second clamping force. The inner ring and the outer ring may be configured to rotate in unison to cause the jaw assembly to clamp the tool bit at the first clamping force and the second ring may be configured to rotate relative to the first ring to cause the jaw assembly to clamp the tool bit at the second clamping force. The jaw assembly may have a first clamping interface at a first angle relative to the axis and a second clamping interface at a second angle relative to the axis that is less than the first angle. The second jaw portion may directly engage the tool bit and the first jaw portion, and the first jaw portion may directly engage the second jaw portion and the clamping ring. A first clamping interface may be defined between the first jaw portion and the second jaw portion and the second clamping interface may be defined between the first jaw portion and the clamping ring. The first clamping surface may be oriented at a first angle relative to the axis and the second clamping surface may be oriented at a second angle relative to the axis that is less than the first angle.

An outer sleeve may be received over the clamping ring so that the outer sleeve and clamping ring rotate together. The clamping ring may be threadably connected to the chuck body. Relative rotation between the clamping ring and the chuck body may cause the jaw assembly to clamp the tool bit at the first force and the second force. The relative rotation between the clamping ring and the chuck body may encompass holding one of the clamping ring and the chuck body rotationally stationary while rotating the other of the clamping ring and the chuck body. The relative rotation may encompass holding the clamping ring rotationally stationary by a user grasping the outer sleeve while the chuck body rotates by actuating a motor in the power tool. The relative rotation may encompass the outer sleeve being coupled to a lock mechanism that selectively locks the outer sleeve to a housing of the power tool to inhibit rotation of the outer sleeve and the clamping ring, while the chuck body rotates by actuating a motor in the power tool. The relative rotation may encompass rotating the outer sleeve to rotate the clamping ring, while the body is held substantially stationary by a spindle lock in the power tool. The jaw assembly may be biased away from clamping the tool bit by at least one spring. The at least one spring may comprise a first spring biasing the jaw assembly away from the chuck body in a direction substantially transverse to the axis.

In an aspect, a chuck for a power tool includes a chuck body extending along a chuck axis and couplable to an output spindle of a power tool. A longitudinal bore is defined in the body along the axis for receiving a tool bit therein. A plurality of jaws is received in the body and moveable radially but not axially, to engage and removably retain the tool bit in the chuck body. A sleeve is received over the body. A first gear is received in the body and rotatable by rotation of the sleeve or the output spindle. A second gear is received in the body, meshed with the first gear, and coupled to at least one of the plurality of jaws, the second gear configured to rotate and cause the at least one jaw to move radially, but not axially, independently of a chuck key, to engage the tool bit or disengage the tool bit upon rotation of the first gear.

Implementations of this aspect may include one or more of the following features. The first gear may comprise a first bevel gear and the second gear may comprise a second bevel gear. Each of the plurality jaws may be received in a radial opening that is communication with the longitudinal bore. Each of the at least one jaw may be threadably engaged with the second gear so that rotation of the second gear causes radial movement of the at least one jaw. The first gear may be rotatable by rotation of the sleeve or the output spindle independent of a chuck key. The second gear may include a plurality of second gears, with each of the second gears coupled to one of the plurality of jaws. The first gear may comprise a ring shaped bevel gear, and each of the second gears may comprise a bevel gear meshed with the ring shaped bevel gear. The sleeve may be moveable axially between a chuck mode position and a drill mode position. When the sleeve is in the chuck mode position, rotation of the output spindle may cause the first gear to rotate. In the sleeve is in the chuck mode position, the sleeve may rotationally lock the body to a housing of the power tool. When the sleeve is in the drill mode position, rotation of the output spindle may cause the body to rotate and drive a tool bit retained in the longitudinal bore. A brake may be coupled to the sleeve. When the sleeve is in the drill mode position, the brake may rotationally couple the first gear to the body so that the body, the first gear, and the output spindle rotate together. When the sleeve is in the chuck mode position, the brake may decouple the first gear from the body to enable the output spindle and first gear to rotate relative to the body. When the sleeve is in the drill mode position, the sleeve may be rotatable relative to a housing of a power tool to change a clutch setting of the power tool. The power tool housing may include an electronic clutch and the sleeve may be rotatable to change a clutch setting of the electronic clutch when the sleeve is in the drill mode position.

In another aspect, a chuck for a power tool includes a chuck body extending along a chuck axis and couplable to an output spindle of a power tool. A longitudinal bore is defined in the body along the axis for receiving a tool bit therein. A plurality of jaws is received in the body and moveable to engage and removably retain the tool bit in the chuck body. A sleeve is received over the body. A first ring shaped bevel gear is received in the body and rotatable by rotation of the output spindle or the sleeve. A plurality of second bevel gears is received in the body and meshed with the first gear. Each of the second bevel gears is coupled to one of the plurality of jaws. The second gears are configured to rotate and cause the jaws to engage the tool bit or disengage the tool bit upon rotation of the first gear.

Implementations of this aspect may include one or more of the following features. The second gears may be spaced circumferentially around the longitudinal bore. Each of the jaws may be received in a radial opening that is communication with the longitudinal bore. Each of the jaws may be threadably engaged with one of the second gears so that rotation of the second gear causes radial movement of the jaw. The first gear may be rotatable by rotation of the sleeve or the output spindle independent of a chuck key. The sleeve may be moveable axially between a chuck mode position and a drill mode position. When the sleeve is in the chuck mode position, rotation of the output spindle may cause the first gear to rotate. When the sleeve is in the chuck mode position, the sleeve may rotationally lock the body to a housing of the power tool. When the sleeve is in the drill mode position, rotation of the output spindle may cause the body to rotate and drive a tool bit retained in the longitudinal bore. A brake may be coupled to the sleeve. When the sleeve is in the drill mode position, the brake may rotationally couple the first gear to the body so that the body, the first gear, and the output spindle rotate together. When the sleeve is in the chuck mode position, the brake may decouple the first gear from the body to enable the output spindle and first gear to rotate relative to the body. When the sleeve is in the drill mode position, the sleeve may be rotatable relative to a housing of a power tool to change a clutch setting of the power tool. The power tool housing may include an electronic clutch. The sleeve may be rotatable to change a clutch setting of the electronic clutch when the sleeve is in the drill mode position.

In another aspect, a power tool includes a tool housing, a motor disposed in the housing, an output spindle drivingly coupled to the motor and extending along a longitudinal axis, and a controller received in the housing and configured to control power delivery to the motor. An electronic clutch is in communication with the controller and configured to sense a tool operating parameter that correlates to an output torque of the output spindle. The electronic clutch is configured to cause the controller to interrupt or reduce power to the motor when the operating parameter indicates that the output torque exceeds a threshold value. A chuck is coupled to the output spindle. The chuck includes a body extending along the longitudinal axis. A longitudinal bore is defined in the body along the longitudinal axis for receiving a tool bit therein. A plurality of jaws is received in the body and moveable to engage or disengage the tool bit received in the bore. A is sleeve received over the body and is moveable axially between a first position in which the sleeve is configured to enable the jaws to be moved to engage or disengage the tool bit, and a second position in which the sleeve is rotatable to change a setting of the electronic clutch.

Implementations of this aspect may include one or more of the following features. The electronic clutch may include a printed circuit board disposed at least partially around the output spindle. In the second position, the sleeve may engage a wiper to change a position of the wiper along the printed circuit board to change the clutch setting. The drill housing may include a plurality of recesses. In the second position, the sleeve may be coupled to a detent that successively engages one or more of recesses as the sleeve is rotated to provide tactile feedback of the clutch setting. The sleeve may have indicia to indicate the clutch setting. In the first position, the sleeve may fix the chuck body to the tool housing so that operation of the motor causes the jaws to engage or disengage the tool bit.

In another aspect, a chuck constructed in accordance to one example of the present teachings can include a chuck body that supports a plurality of jaws. An outer sleeve is axially fixed with respect to the chuck body. A nut is coupled to the outer sleeve, the nut being movable axially and radially relative to the chuck body. The nut interacts with the jaws such that when the outer sleeve rotates, the nut moves axially and radially relative to the body.

Implementations of this aspect may include one or more of the following features. When the nut moves axially and radially relative to the chuck body, the jaws may move towards or away from one another. The chuck may have a front end at which the jaws extend from the chuck and are configured to hold a bit. The jaws may move away from one another when the nut moves axially toward the front end. The chuck may have a rear end opposite the front end. The jaws may move towards one another when the nut moves axially toward the rear end. The nut may include internal threads. The jaws may include external threads that mesh with the internal threads on the nut.

In another aspect, a power tool constructed in accordance to one example of the present teachings can include a housing, a motor and a chuck. The chuck is configured to hold an accessory. The chuck is selectively driven by the motor. The chuck includes a chuck body; a plurality of jaws disposed at least partially in the chuck body; a chuck sleeve that is axially fixed with respect to the chuck body, and is selectively rotatable with respect to the chuck body; and a nut coupled to the outer sleeve, the nut being movable axially and radially relative to the chuck body. The nut interacts with the jaws such that when that outer sleeve rotates, the nut moves axially and radially relative to the body.

Implementations of this aspect may include one or more of the following features. When the nut moves axially and radially relative to the body, the jaws may move towards or away from one another. The chuck may have a front end at which the jaws extend from the chuck and are configured to hold a bit. The jaws may move away from one another when the nut moves axially toward the front end. The chuck may have a rear end opposite the front end. The jaws may move towards one another when the nut moves axially toward the rear end. The nut may include internal threads. The jaws may include external threads that mesh with the internal threads on the nut.

In another aspect, a chuck constructed in accordance to one example of the present teachings can include a chuck body; a plurality of jaws, the plurality of jaws configured to hold a bit; an outer sleeve, the outer sleeve being axially fixed relative to the chuck body, the outer sleeve also being selectively rotatable with respect to the chuck body; and a nut coupled to the outer sleeve, wherein the nut is located internally of the outer sleeve and is movable axially and radially relative to the chuck body. The nut may include a nut threaded portion on an internal surface of the nut. The jaws may include a jaws threaded portion on an external portion of the jaws. The nut threaded portion may be engaged with the jaws threaded portion. When the outer sleeve rotates, the nut may move axially and radially relative to the body.

Implementations of this aspect may include one or more of the following features. When the nut moves axially and radially relative to the body, the jaws may move towards or away from one another. The chuck may have a front end at which the jaws extend from the chuck and are configured to hold a bit. The jaws may move away from one another when the nut moves axially toward the front end. The chuck may have a rear end opposite the front end. The jaws may move towards one another when the nut moves axially toward the rear end. The chuck may further include a lifter which pushes the jaws away from one another. The jaws may be axially fixed relative to the chuck body. The jaws may be axially fixed relative to the outer sleeve. The nut may have a frustoconical shape.

In another aspect, a chuck constructed in accordance with one example of the present teachings can include a chuck. The chuck includes a chuck body that supports a plurality of jaws. The chuck also includes an outer sleeve is axially fixed with respect to the chuck body and selectively rotatable with respect to the chuck body. The chuck further includes a cam core having a plurality of ramped inner surfaces. The jaws have outer surfaces in contact with the ramped inner surfaces. When the cam core rotates relative to the jaws, the ramped inner surfaces of the cam core push the jaws towards one another or away from one another. The chuck has a front at which the plurality of jaws are configured to hold a bit and a rear, opposite the front. The cam core may move axially rearwardly when the plurality of jaws are tightened around the bit.

Implementations of this aspect may include one or more of the following features. The cam core may have an outer circumferential surface. There may be a slot in the outer circumferential surface. The chuck may further include a connector which selectively transmits force from the outer sleeve to the cam core. The connector may have a first end engaged with the outer sleeve and a second end engaged with the slot. The slot may have a first end and a second end. The second end may be closer to the rear of the chuck than the first end is to the rear of the chuck. The cam core may further include detents biased radially outwardly. The outer sleeve may further include detent recesses which selectively engage the detents.

In another aspect, a power tool constructed in accordance with one example of the present teachings may include a power tool with a chuck. The power tool includes a housing, a motor disposed in the housing and a chuck configured to hold an accessory. The chuck is selectively driven by the motor. The chuck includes a chuck body that supports a plurality of jaws, an outer sleeve that is axially fixed with respect to the chuck body and is selectively rotatable with respect to the chuck body. The chuck also includes a cam core having a plurality of ramped inner surfaces. The jaws have outer surfaces in contact with the ramped inner surfaces. When the cam core rotates relative to the jaws, the ramped inner surfaces of the cam core push the jaws towards one another or away from one another. The chuck has a front at which the plurality of jaws are configured to hold a bit. The chuck has a rear, opposite the front. The cam core moves axially rearwardly when the plurality of jaws are tightened around the bit.

Implementations of this aspect may include one or more of the following features. The cam core may have an outer circumferential surface. There may be a slot in the outer circumferential surface. The chuck may further include a connector which selectively transmits force from the outer sleeve to the cam core. The connector may have a first end engaged with the outer sleeve and a second end engaged with the slot. The slot may have a first end and a second end. The second end may be closer to the rear of the chuck than the first end is to the rear of the chuck. The cam core may also include detents biased radially outwardly. The outer sleeve may further include detent recesses which selectively engage the detents.

In another aspect, a chuck constructed in accordance with one example of the present teachings can include a chuck. The chuck includes a plurality of jaws, a chuck sleeve and a cam core. Each of the plurality of jaws may include a clamping surface configured to engage a bit and each of the plurality of jaws also including an outer surface. The chuck sleeve is selectively rotatable with respect to the plurality of jaws. The cam core has a plurality of ramped surfaces. The chuck has a front end at which the bit is inserted. The chuck has a rear end, opposite the front end, at which the chuck is operatively engaged with a motor of a power tool. Totation of the chuck sleeve in a first direction causes the jaws to move from an open position towards one another to a closed position in which the bit is engaged and held by the jaws. The cam core moves towards the rear end of the chuck when the jaws are tightened on the bit.

Implementations of this aspect may include one or more of the following features. The cam core may be connected to the chuck sleeve by at least one connector. The connector may urge the cam core towards the rear end of the chuck when the jaws are tightened on the bit. The cam core may include a radial outer surface. The cam core may include a slot in the radial outer surface. The slot may include a first end and a second end. The first end of the slot may be closer to the front end of the chuck than the second end of the slot is to the front end of the chuck. The chuck may further include a connector connecting the chuck sleeve and the cam core. An end of the connector may be engaged with and movable along the slot. The cam core may also include detents biased radially outwardly. The chuck sleeve may also include detent recesses which selectively engage the detents. The chuck may be part of a power tool. The power tool may be a powered drill. The powered drill may be powered by a battery pack. The chuck may include three jaws. Each of the three jaws may have an outer surface which is inclined. The detent recesses may include ramped surfaces configured to depress a detent plunger. The cam core may have three ramped surfaces.

Advantages may include one or more of the following. The chucks of this application have improved holding force due, in part, to the mechanical advantage achieved with the bevel gears. In addition, the bevel gears, which cause the jaws to move radially but not axially, reduces the axial length of the chucks, which reduces the overall length of the power tool. In addition, the chucks of this application integrate the clutch setting with the chuck sleeve, further reducing the number of components and overall length of the power tool. The chucks may have improved clamping force due to clamping the tool bit in a first phase with a first clamping force up to a first maximum clamping force and in a second phase with a second clamping force that exceeds the first maximum clamping force. This may be achieved, in part, by having a clamping ring and a jaw assembly together defining first and second clamping interfaces at different angles to the longitudinal axis. In addition, because the jaw assembly movement is primarily in the radial direction, this reduces the axial length of the chuck, which reduces the overall length of the power tool. These and other advantages and features will be apparent from the description and drawings.

### BRIEF DESCRIPTION OF THE DRAWINGS

FIG. 1 is a side view of an embodiment of a power tool and chuck.

FIG. 2 is a side view of the power tool and chuck of FIG. 1, partially in cross-section.

FIG. 3 is an exploded view of the chuck of FIG. 1.

FIGS. 4A-4D are close-up exploded views of the chuck body and jaw assemblies of the chuck of FIG. 1.

FIGS. 5A-5E are exploded views of the chuck of FIG. 1.

FIGS. 6A-6B are cross-sectional views of the chuck of FIG. 1 showing operation of the chuck.

FIG. 7A is a perspective view of the power tool and chuck of FIG. 1, partially in cross-section.

FIG. 7B is a close-up perspective view of the brake assembly of the power tool and chuck of FIG. 1.

FIG. 8 is a side view of a second embodiment of a power tool and chuck.

FIG. 9 is an exploded view of the chuck of FIG. 8.

FIGS. 10A-10C are close-up exploded views of the chuck body and jaw assemblies of the chuck of FIG. 8.

FIGS. 11A-11B are close-up exploded views of the clamp ring of the chuck of FIG. 8.

FIGS. 11C-11D are close-up views of the assembled clamp ring of the chuck of FIG. 8.

FIGS. 12A-12E are exploded views of the chuck of FIG. 8.

FIGS. 13A-13D are cross-sectional views of the chuck of FIG. 8, showing operation of the chuck.

### DETAILED DESCRIPTION

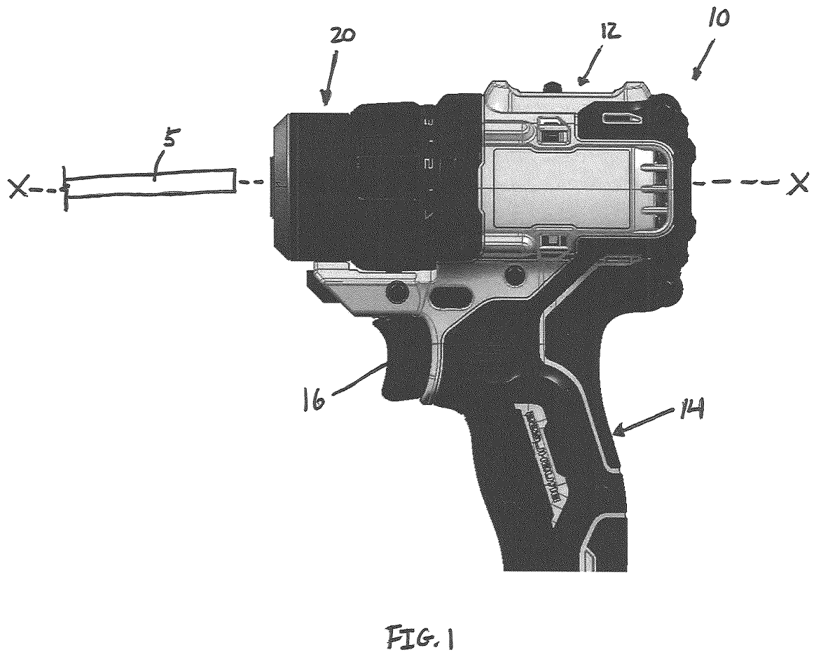

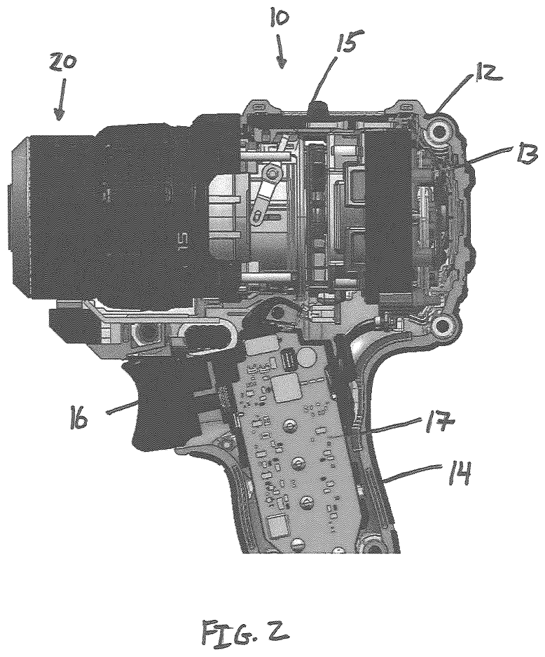

Referring to FIGS. 1 and 2, a power tool 10 includes a tool housing 12 that contains a motor 13 and a transmission 15. A handle 14 extends downward from the housing 12 includes a printed circuit board 17 that includes a motor control circuit. Coupled to the handle 14 is a trigger switch 16 that receives a user input and controls power delivery to the motor. Connected to the handle 14, but not shown, is a battery receptacle that receives a battery for powering the motor and/or a power cord for receiving input of AC power. A keyless chuck 20 for removably receiving and retaining a tool bit 5 extends along a longitudinal axis X and is coupled to, and may be integral with, the tool housing 12. Operation of the power tool 10 is accordance with known power tools, such as drills or screwdrivers.

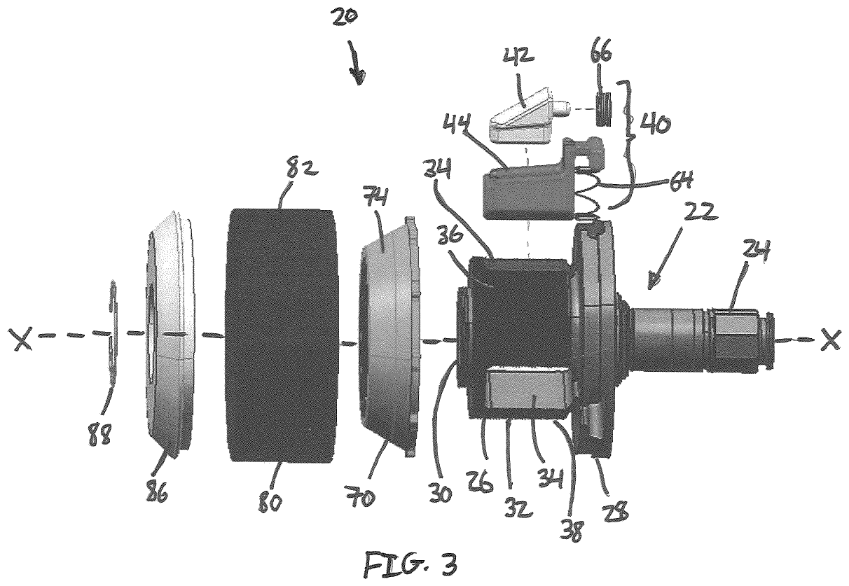

Referring also to FIG. 3, the chuck 20 includes a chuck body 22 that extends generally along a longitudinal axis X. The chuck body 22 includes an input shaft 24 extending along the axis and couplable to an output spindle (not shown) of a power tool 10. Alternatively, the input shaft 24 may be integral with or simply be the output spindle of the power tool 10. The chuck body 22 also includes a generally cylindrical front portion 26 and a flange 28 disposed between the front portion 24 and the input shaft 24. The front portion 26 of the chuck body 22 defines a longitudinal bore 30 along the axis X for receiving the tool bit 5 therein. The chuck body 22 also has a sidewall 32 that defines a plurality (in this case three) radial slots 34 in communication with the longitudinal bore 30. An outer surface 36 of the sidewall 32 has a first thread 38.

A plurality of jaw assemblies 40 (one of which is shown in FIG. 3) are received in the chuck body 22, with each jaw assembly 40 at least partially received in one of the plurality of radial slots 34. Each jaw assembly 40 is moveable to engage and removably retain the tool bit 5 in the bore 30 of the chuck body 22. The jaw assembly 40 is configured to jaw assembly to clamp the tool bit 5, in a first phase, with a first clamping force up to a first maximum clamping force, and, in a second phase, with a second clamping surface that is greater than the first maximum clamping force.

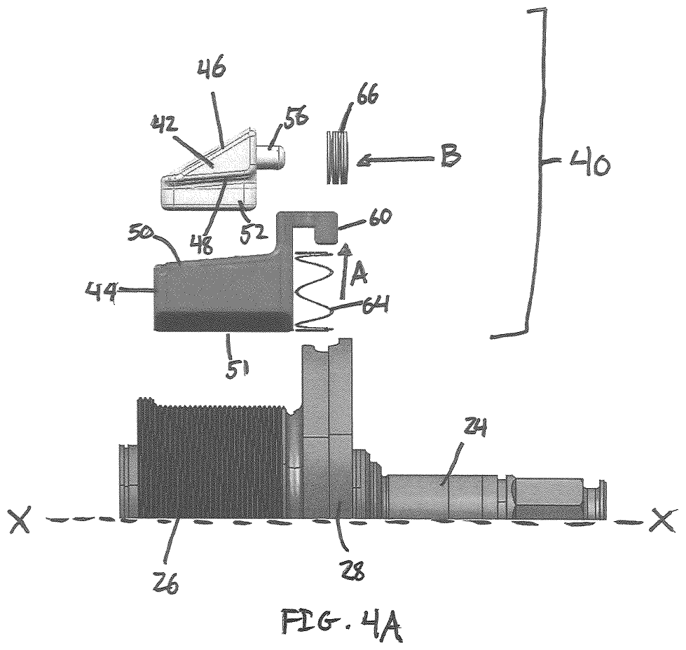

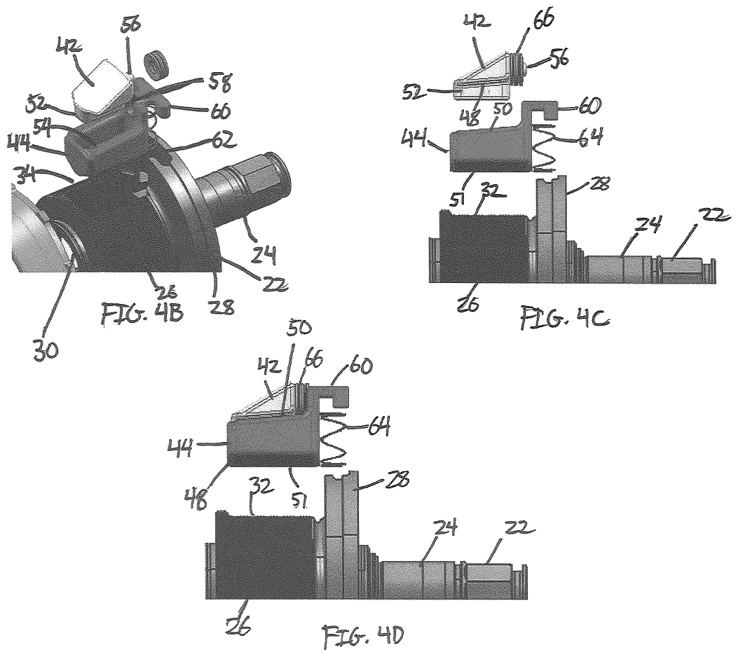

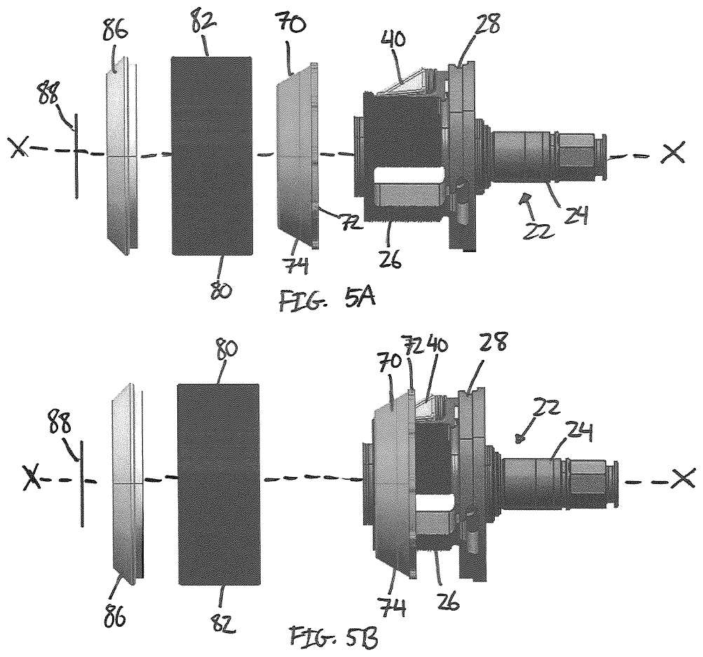

Referring also to FIGS. 4A-4D, each jaw assembly 40 includes a first jaw portion 42 and a separate second jaw portion 44. The first jaw portion 42 is generally wedge shaped, and has a top clamping surface 46 and a bottom clamping surface 48. The second jaw portion 44 is generally rectilinearly shaped and includes a top clamping surface 50 that abuts the bottom clamping surface 48 of the first jaw portion 42, and a bottom clamping surface 51 that is configured to engage the tool bit 5 and that is generally parallel to the longitudinal axis X.

The first jaw portion 42 also includes a generally rectilinear downwardly directed protrusion 52 that is received in a correspondingly shaped top recess 54 in the second jaw portion 44. The first jaw portion 42 further includes a rearwardly directed cylindrical peg 56 that is configured to be received in a corresponding slot 58 in the second jaw portion 44. The second jaw portion 44 includes a rearwardly directed generally T-shaped tang 60 that is configured to be received in a corresponding slot 62 in the flange 28 of the chuck body 22. A first compression spring 64 is disposed between the T-shaped tang 60 and the bottom of the slot 62 and is configured to bias the second jaw portion 44 away from the chuck body 22 in a direction A that is generally transverse (e.g., orthogonal) to the longitudinal axis X. A second disk spring 66 is received over the peg 56 and is configured to bias the first jaw portion 42 in a direction B that is generally parallel to the longitudinal axis X.

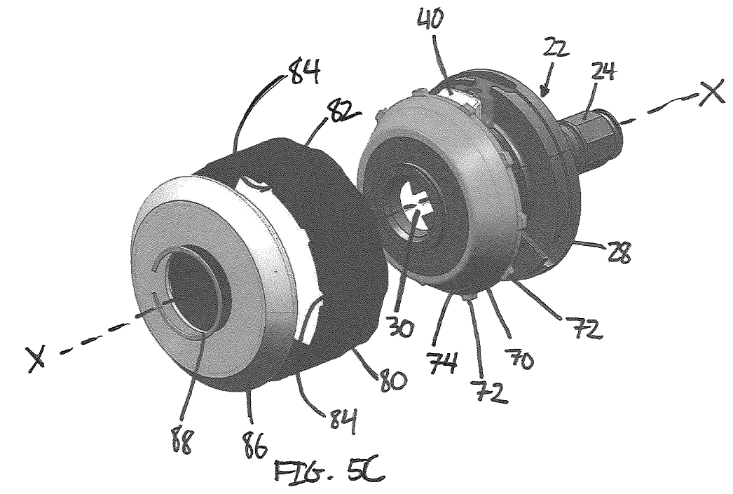

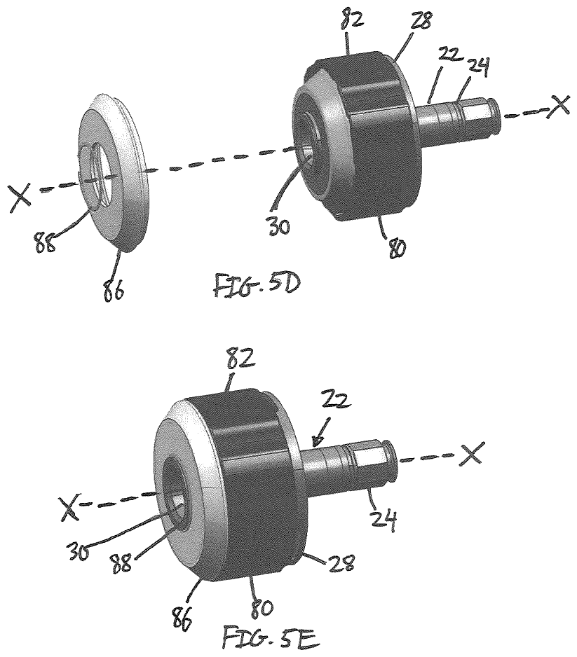

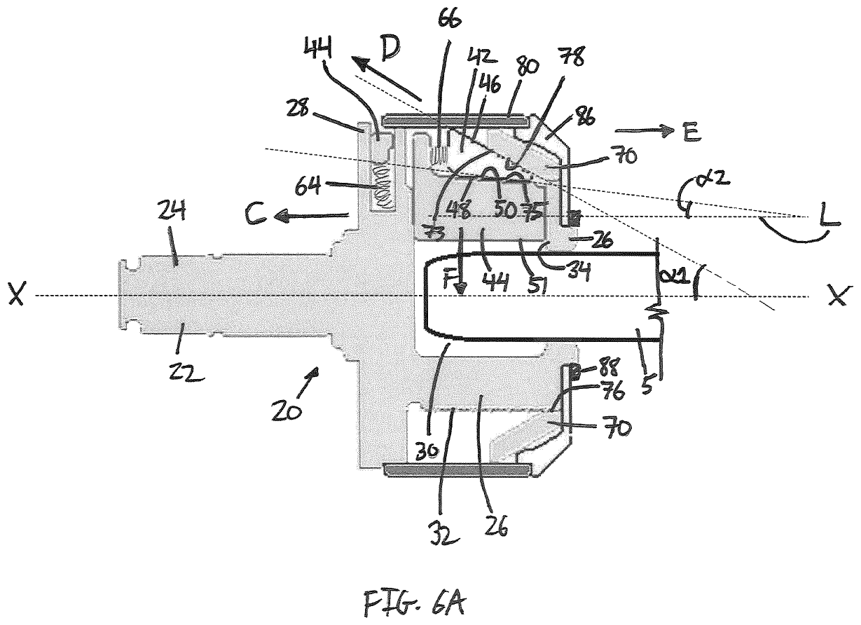

Referring also to FIGS. 5A-5E, a generally frustroconical clamping ring 70 is received over the front portion 26 of the chuck body 22 and the jaw assemblies 40. The clamping ring 70 has a generally cylindrical threaded inner surface 76 that is threaded onto the first thread 38 on the front portion 26 of the chuck body 22 so that when the clamping ring 70 rotates relative to the chuck body 22, the clamping ring 70 translates relative to the chuck body 22 along the longitudinal axis X. An outer sleeve 80 is received over the clamping ring 70 and the front portion 26 of the chuck body 22. The outer sleeve 80 has an external gripping surface 82 and a plurality internal of longitudinal grooves 84 that engage a plurality of projections 72 on an outer surface 74 of the clamping ring 70 so that the outer sleeve 80 and clamping ring 70 rotate together. A generally frustroconical nosepiece 86 is received in a front end of the sleeve 80 and is retained on the sleeve 80 and the chuck body 22 by a C-ring 88. The nosepiece 86 may be rotatable relative to the sleeve 80 or may be configured to rotate together with the sleeve 80.

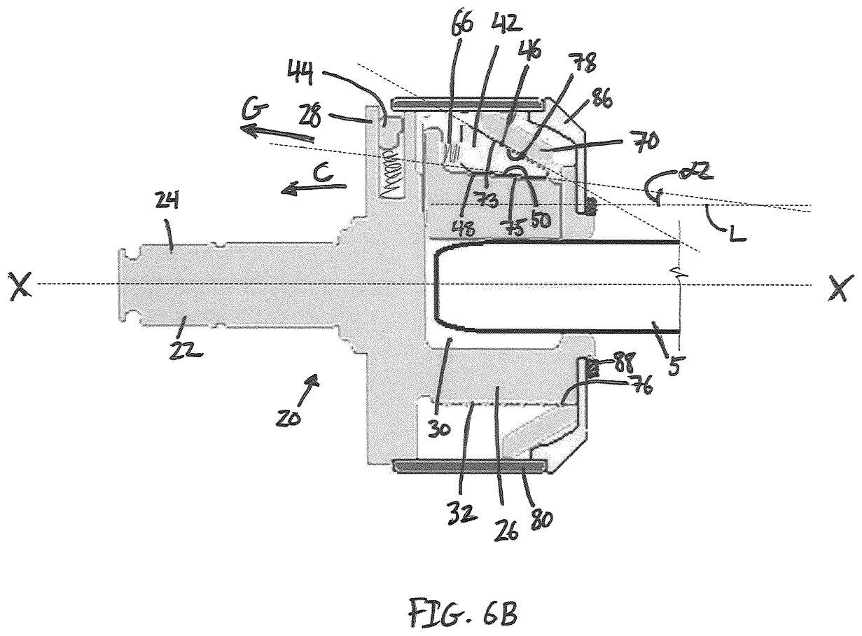

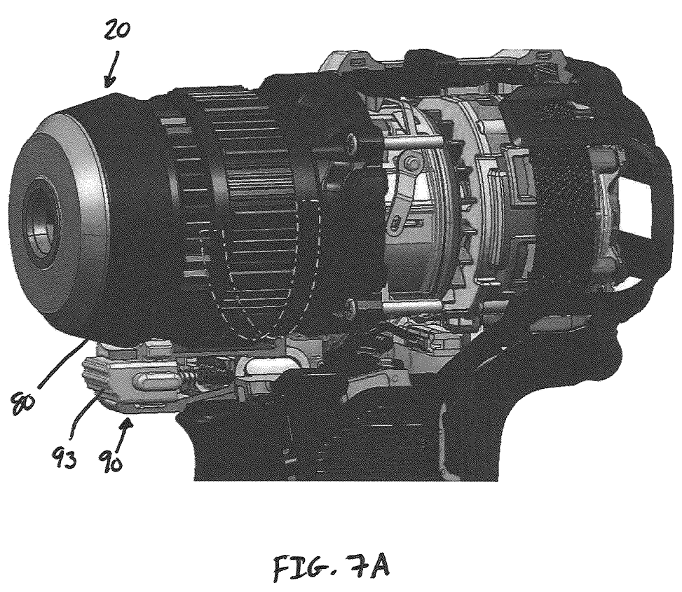

Referring also to FIGS. 6A-6B, the clamping ring 70 further includes an inner clamping surface 78 that abuts the top clamping surface 46 of the first jaw portion 42. When assembled, the inner clamping surface 78 of the clamping ring 70 and the top clamping surface 46 of the first jaw portion together define a first clamping interface 73 that is disposed at a first acute angle ?1 to the longitudinal axis X (e.g., approximately 30° to approximately 60°). The bottom clamping surface 48 of the top jaw portion 42 and the top clamping surface 50 of the bottom jaw portion 44 together define a second clamping interface 75 that is disposed at a second acute angle ?2 to the longitudinal axis X that is less than the first acute angle ?1 (e.g., approximately 1° to approximately 15°).

In operation, the chuck 20 is actuatable to clamp or release a bit between the jaw assemblies 40 when there is relative movement between the clamping ring 70 and outer sleeve 80, on the one hand, and the chuck body 22, on the other hand. Such relative motion can be achieved by holding the outer sleeve 80 and clamping ring 72 rotationally stationary (e.g., by a user grasping the outer sleeve 80 to prevent rotation or by locking the outer sleeve 80 to the tool housing 12, as described below), while actuating the motor to rotate the output spindle of the power tool and the chuck body 22. Alternatively, the output spindle can be coupled to a spindle lock which prevents backdriving of the output spindle when a torque is applied to the chuck 20 by a user. In this manner the chuck body 22 remains rotationally stationary while a user rotates the outer sleeve 80 and clamping ring 70 to clamp or release a tool bit 5 between the jaw assemblies 40.

The clamping of a tool bit 5 between the jaw assemblies 40 occurs in two phases. Referring to FIG. 6A, during a first clamping phase, relative rotation between the clamping ring 70 and the chuck body 22 causes the clamping ring 70 to move axially rearward in a direction C that is parallel to the longitudinal axis X. The inner clamping surface 78 of the clamping ring 70 slides along the top clamping surface 46 of the first jaw portion 42 (i.e., along the first interface 73) in a direction D. At the same time, the disk spring 66 biases the first jaw portion 42 axially forward in a direction E so that no relative motion occurs between the bottom clamping surface 48 of the first jaw portion 42 and the top clamping surface 50 of the second jaw portion 44 (i.e., along the second clamping interface 75). This is because the second clamping interface 75 is orientated at a smaller angle relative to the longitudinal axis X than the first clamping interface 73. Thus, the top jaw portion 42 and bottom jaw portion 44 move radially inward in unison in a direction F that is transverse to the longitudinal axis X and clamps the tool bit 5 with a first clamping force up to a maximum first clamping force.

Referring to FIG. 6B, once the bottom clamping surface 51 of the bottom jaw portion 44 clamps the tool bit 5 with the maximum first clamping force, the second clamping phase begins. As the clamping ring 70 continues to rotate and move axially rearward in the direction C, the friction force between the top clamping surface 46 of the first jaw portion 42 and the clamping surface 78 of the clamping ring 70 (i.e., the first clamping interface 73) exceeds the friction force between the bottom clamping surface 48 of the first jaw portion 42 and the top clamping surface 54 of the second jaw portion 44 (i.e., the second clamping interface 75) and the spring force supplied by the disk spring 66. This causes the relative motion between the clamping ring 70 and the first jaw portion 42 along the first clamping interface 73 to stop, and relative motion of the first jaw portion 42 and the second jaw portion 44 along the second clamping interface 75 to start. Thus, the clamping ring 70 will continue to rotate and translate in the direction C. The first jaw portion 42 will slide along the second clamping interface 75 in a direction G that is parallel to the second angle ?2. This causes the second jaw portion 44 to move in the direction F that is transverse (e.g., orthogonal) to the longitudinal axis X so that the jaw assembly 40 clamps the tool bit 5 at a second clamping force that is greater than the maximum first clamping force. These movements will continue until the disk spring 66 bottoms out or until the force acting on the second clamping interface 75 becomes too great for torque being inputted to continue rotating and translating the clamping ring 70. Thus, the combination of initial tightening along the first clamping interface 73 to a first maximum force and further tightening along the second clamping interface 75 to a force that is greater than the first maximum force provides enhanced holding force on the tool bit 5 in a compact assembly.

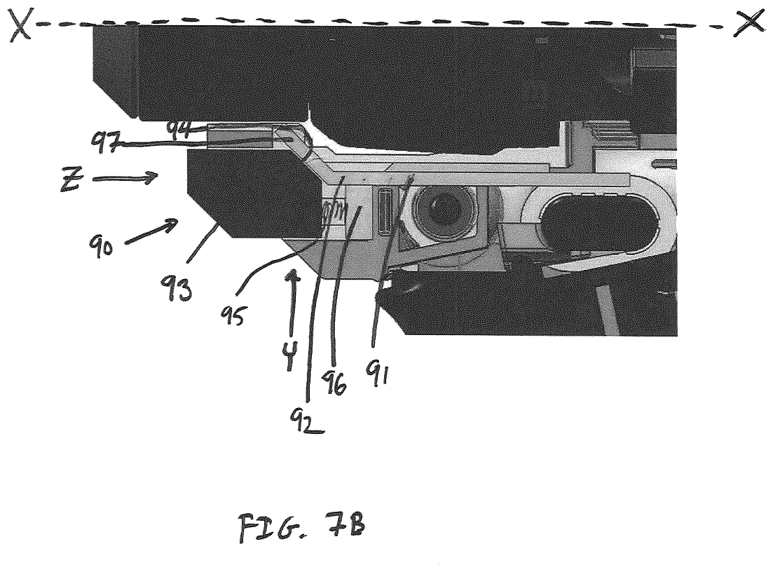

Referring also to FIGS. 7A-7B, the power tool 10 may optionally include a brake assembly 90 configured to hold the outer sleeve 80 and clamping ring 70 rotationally stationary relative to the tool housing 12 while tightening or loosening the chuck 20, so that the chuck 20 can be tightened or loosened by activating the motor 13 to rotate the chuck body 22. The brake assembly 90 includes a brake bar 91 having a longitudinally extending portion 92 that is fixed in the tool housing 12 and a flexible tang 97. A button 93 is disposed beneath the chuck 20 and has an inclined surface 94 configured to abut the flexible tang 97 and a spring 95 biasing the button 93 axially forward opposite direction Z. The button 93 is axially moveable in a direction Z generally parallel to the longitudinal axis X. When the button 93 is depressed, the inclined surface 94 of the button 93 forces the tang 92 in a transverse direction Y to engage the outer sleeve 80 of the chuck and hold the outer sleeve 80 (and thus also the clamping ring 70) rotationally stationary relative to the tool housing 10. Thus, when the user actuates the motor 13 while the button 93 is depressed, the motor 13 will cause the chuck body 22 to rotate relative to the clamping sleeve 70, causing tightening or loosening of the jaw assemblies 40 on a tool bit 5. When the button 93 is released, the spring 95 pushes the button axially forward, and the tang 92 moves away from the outer sleeve 80, which enables the tool 10 to operate in its normal drilling or driving mode(s). The button 93 may optionally engage an electrical switch 96 when depressed. The electrical switch 96, if engaged, will cause an electrical signal to be communicated to the controller, so that operation of the motor can be adjusted in the chuck tightening or loosening mode. For example, the controller may cause the motor to operate at a lower speed for greater control when tightening or loosening the chuck.

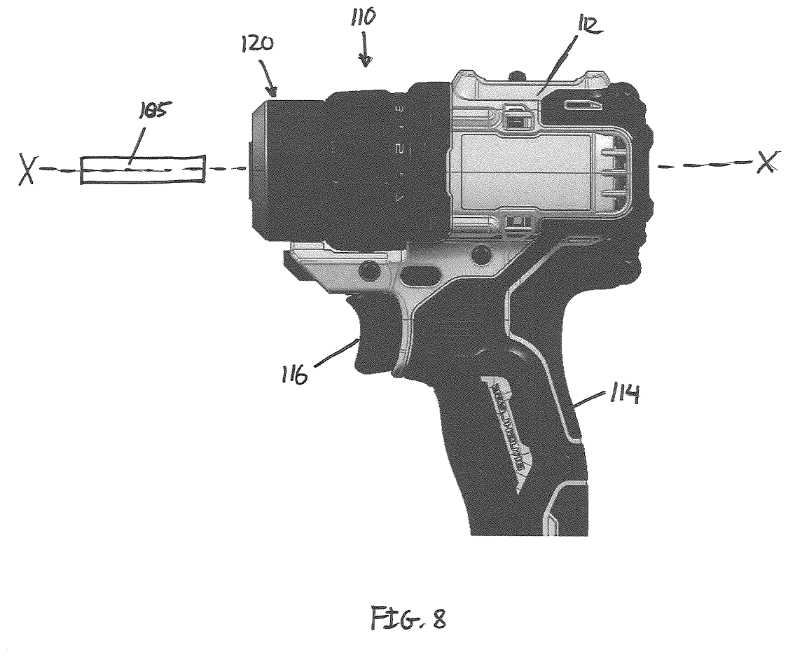

Referring to FIG. 8, in another embodiment a power tool 110 includes a tool housing 112 that contains a motor and a transmission and a handle 114 that extends downward from the housing 112. Coupled to the handle 114 is a trigger switch 116 that receives a user input and controls power delivery to the motor. Connected to the handle 114, but not shown, is a battery receptacle that receives a battery for powering the motor and/or a power cord for receiving input of AC power. A keyless chuck 120 for receiving a tool bit 105 extends along a longitudinal axis X and is coupled to, and may be integral with, the tool housing 112. Operation of the power tool 10 will be accordance with known power tools, such as drills or screwdrivers.

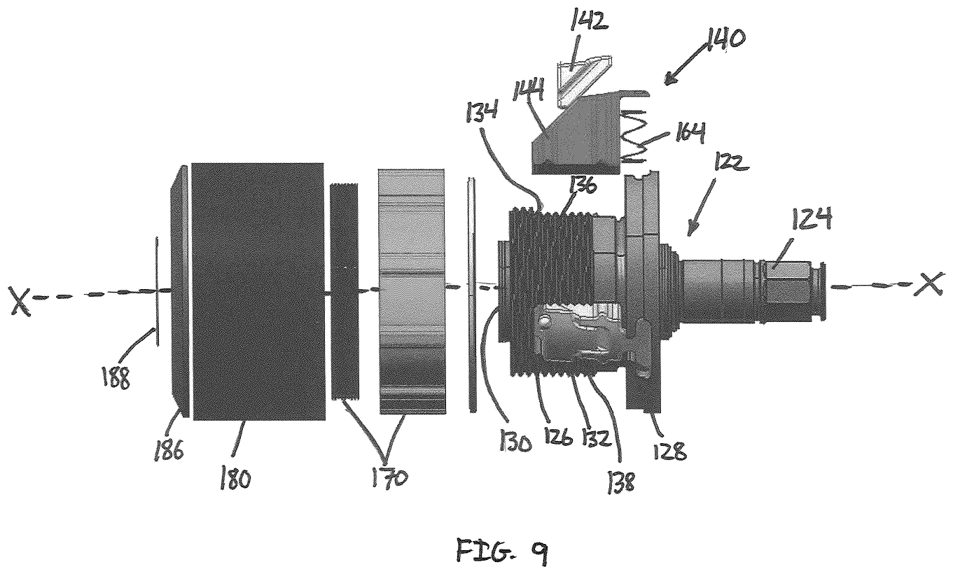

Referring also to FIG. 9, the chuck 120 includes a chuck body 122 that extends generally along the longitudinal axis X. The chuck body 122 includes an input shaft 124 extending along the axis and couplable to an output spindle (not shown) of the power tool 110. Alternatively, the input shaft 124 may be integral with or simply be the output spindle of the power tool 110. The chuck body 122 also includes a generally cylindrical front portion 126 and a flange 128 disposed between the front portion 124 and the input shaft 124. The front portion 126 of the chuck body 122 defines a longitudinal bore 130 along the axis X for receiving a tool bit therein. The chuck body 122 also has a sidewall 132 that defines a plurality (in this case three) radial slots 134 in communication with the longitudinal bore 130. An outer surface 136 of the sidewall 132 has a first thread 138.

A plurality of jaw assemblies 140 (one of which is shown in FIG. 3) are received in the chuck body 122, with each jaw assembly 140 at least partially received in one of the plurality of radial slots 134. Each jaw assembly 140 is moveable to engage and removably retain the tool bit 105 in the chuck body 122 to cause the jaw assembly to clamp the tool bit at a first clamping force up to a first maximum clamping force, and a second clamping surface that exceeds the first maximum clamping force.

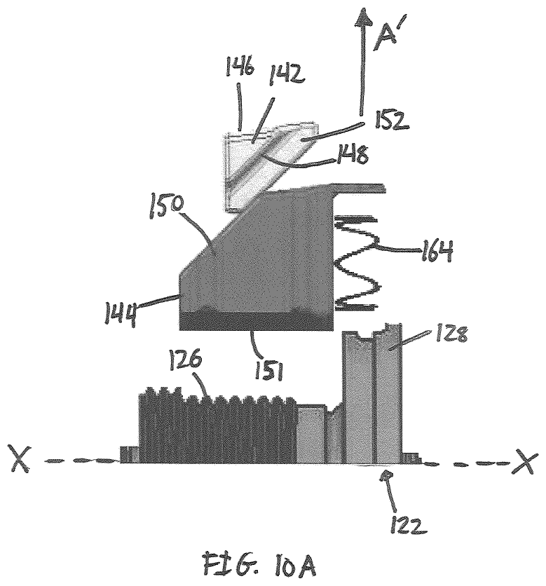

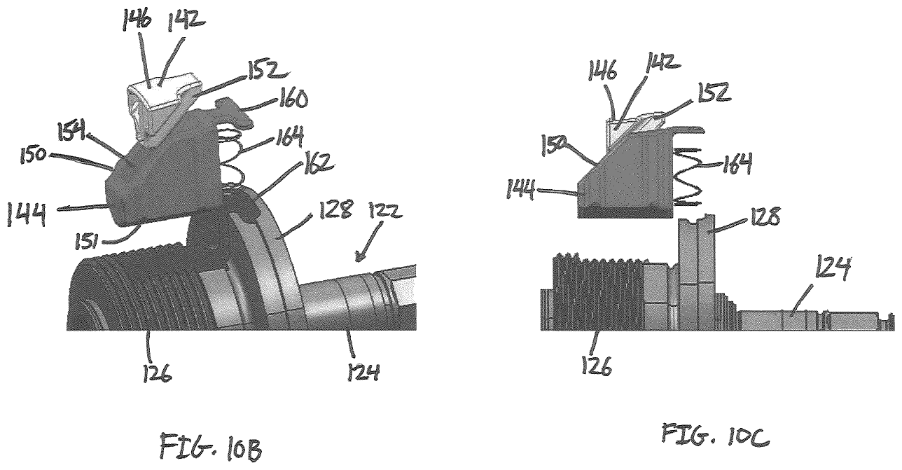

Referring also to FIGS. 10A-10C, each jaw assembly 140 includes a first jaw portion 142 and a separate second jaw portion 144. The first jaw portion 142 is generally wedge shaped, and has a top clamping surface 146 and a bottom clamping surface 148. The second jaw portion 144 is partially wedge shaped and includes a top clamping surface 150 that abuts the bottom clamping surface 148 of the first jaw portion 142, and a bottom clamping surface 151 that is configured to engage the tool bit 105 and that is generally parallel to the longitudinal axis X.

The first jaw portion 142 also includes a downwardly directed protrusion 152 that is received in a correspondingly shaped top recess 154 in the second jaw portion 144. The second jaw portion 144 includes a rearwardly directed generally T-shaped tang 160 that is configured to be received in a corresponding slot 162 in the flange 128 of the chuck body 122. A first compression spring 164 is disposed between the T-shaped tang 160 and the bottom of the slot 162 and is configured to bias the second jaw portion 144 away from the chuck body 122 in a direction A′ that is generally transverse (e.g., orthogonal) to the longitudinal axis X.

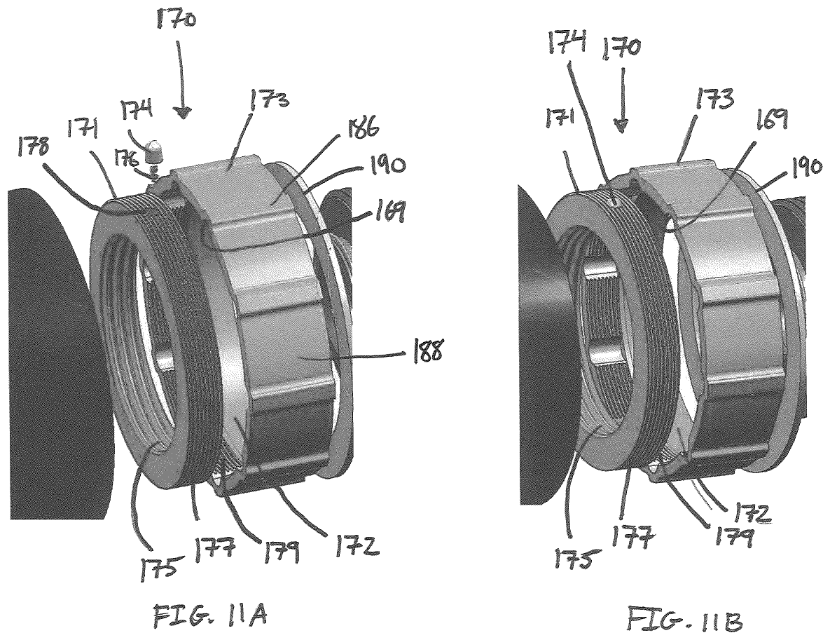

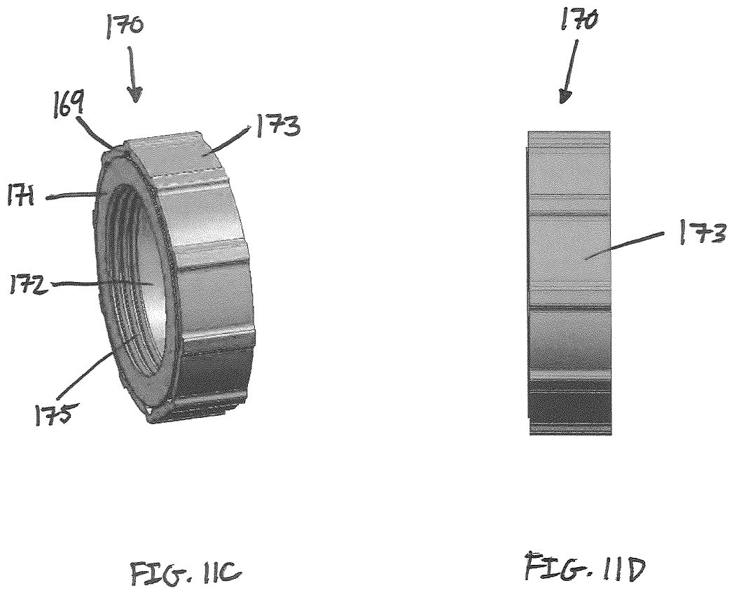

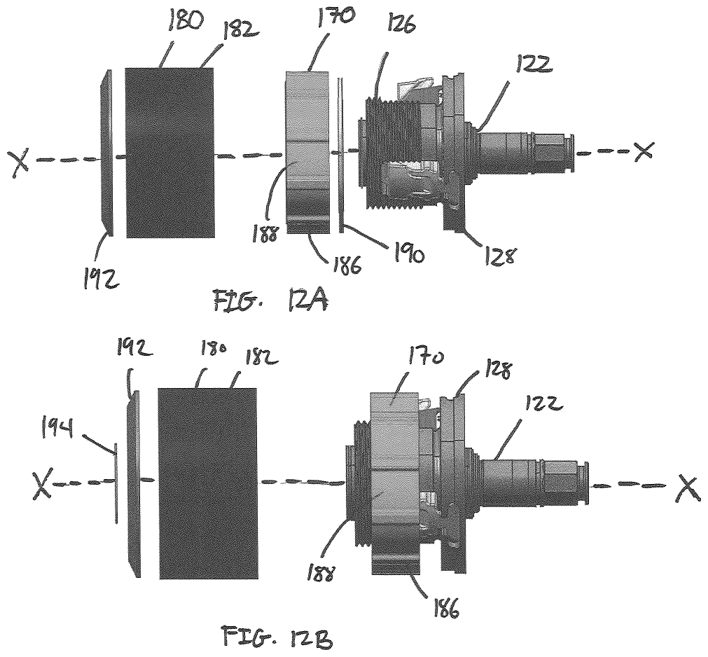

Referring also to FIGS. 11A-11D, a clamping ring 170 is received over the front portion 126 of the chuck body 122 and the jaw assemblies 140. The clamping ring 170 has a generally cylindrical inner clamping ring 171 and a generally cylindrical outer clamping ring 173. The inner clamping ring 171 includes an inner thread 175 threaded onto the thread 138 on the front portion 126 of the chuck body 122 so that when the inner clamping ring 171 rotates relative to the chuck body 122, the inner clamping ring 171 translates relative to the chuck body 122 along the longitudinal axis X. The inner clamping ring 171 also has an outer thread 177 having a finer pitch than the inner thread 175. The outer clamping ring 173 has an inner thread 179 configured to be threaded onto the outer thread 177 of the inner clamping ring 171. The outer clamping ring 173 also has an internal clamping surface 172 configured to engage the top clamping surface 146 of the first jaw portion 142.

The inner clamping ring 171 also has a detent 174 that is biased radially outward by a spring 176 and that is received in a pocket 178 in the outer threaded surface 177 of the ring 175. The outer clamping ring 173 includes a plurality of recesses 169 that interrupt the inner thread 179. Each of the plurality of recesses 169 is configured to receive the detent 174. When the detent is received in one of the recesses 169, the inner clamping ring 171 and the outer clamping ring 173 rotate together as a unit. When the relative torque between inner clamping ring 171 and the outer clamping ring 173 overcomes the radial force exerted by the spring 176 on the detent 174, the detent 174 will slip out of the recesses 169, enabling the inner clamping ring 171 to rotate and translate relative to the outer clamping ring 173 by the threaded engagement of the outer thread 177 and the inner thread 179, as discussed further below.

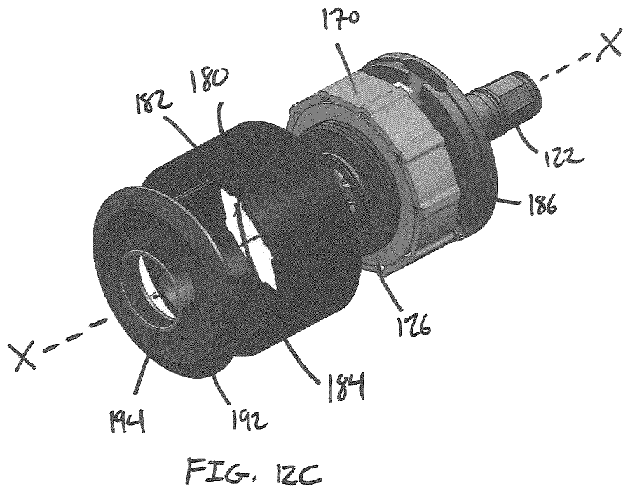

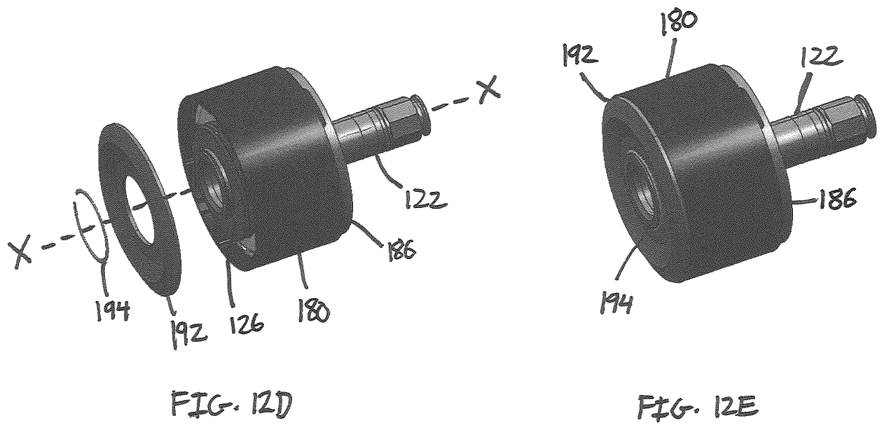

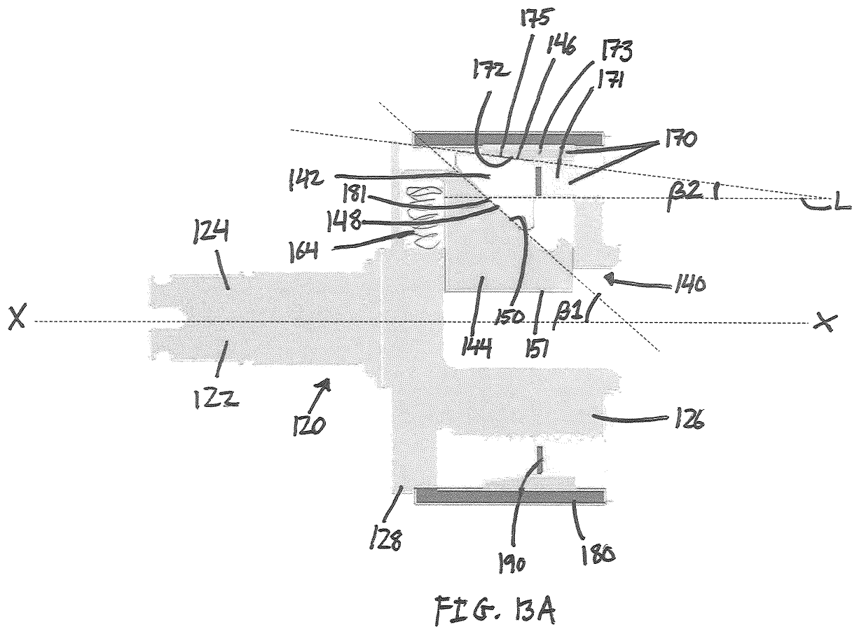

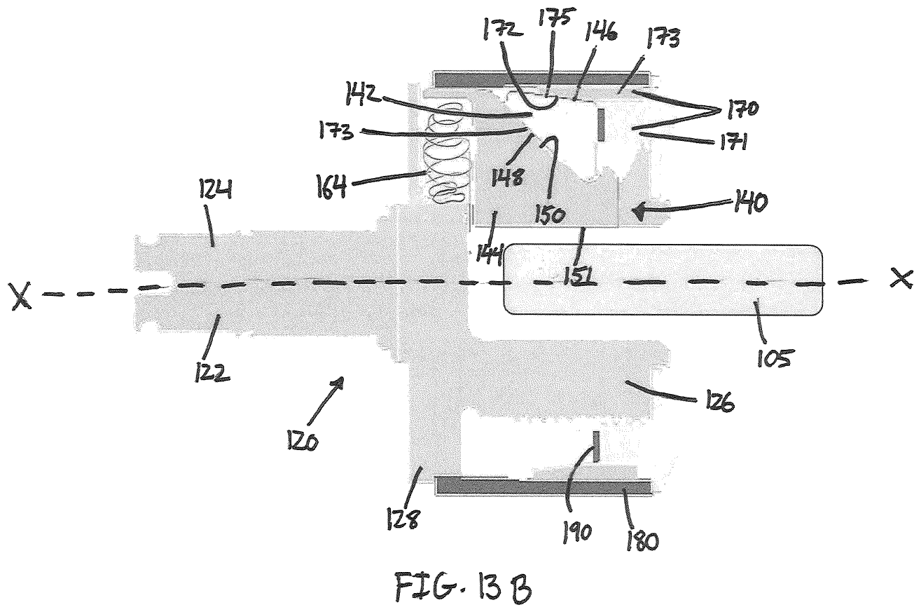

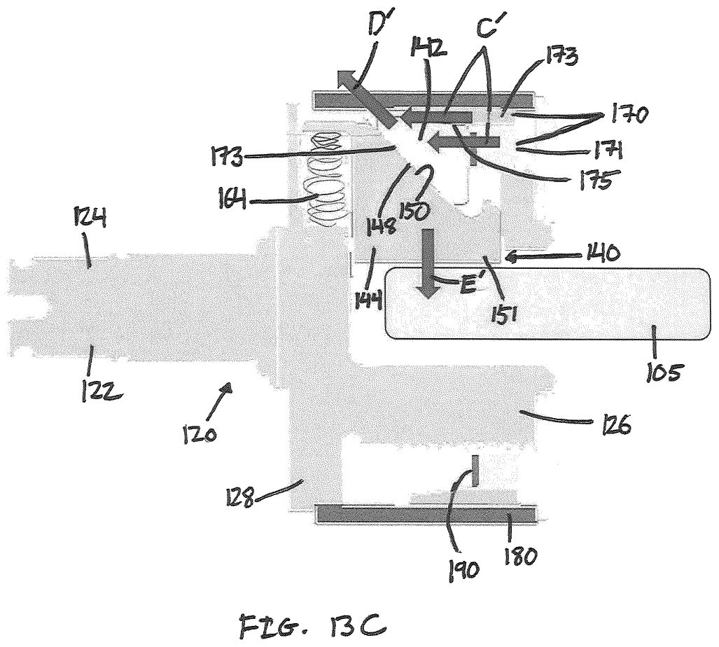

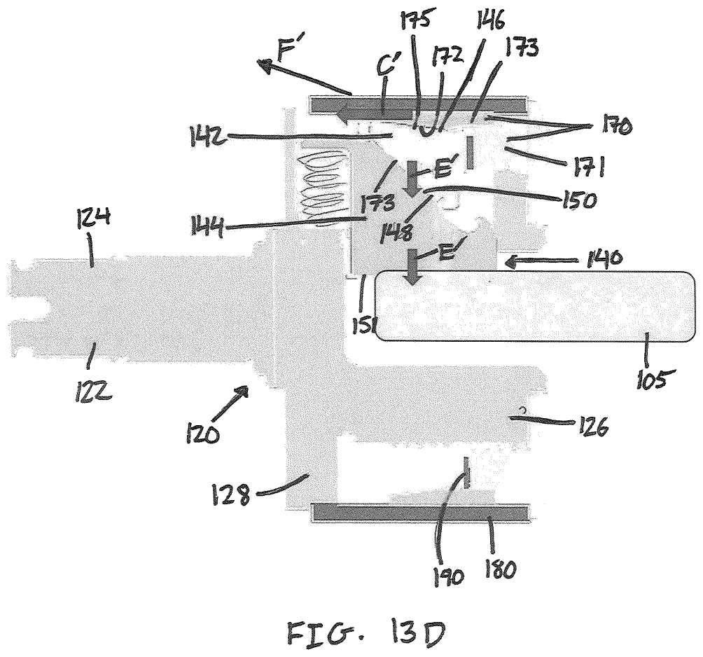

Referring also to FIGS. 12A-12E an outer sleeve 180 is received over the clamping ring 170 and the front portion 126 of the chuck body 122. The outer sleeve 180 has an external gripping surface 182 and a plurality internal of longitudinal grooves 184 that engage a plurality of projections 186 on an outer surface 188 of the clamping ring 170 so that the outer sleeve 180 and clamping ring 170 rotate together. A thrust ring 190 is received over the front portion 126 of the chuck body 122 between the clamping ring 170 and first jaw portion 142 (e.g., as shown in FIG. 13A). A generally frustroconical nosepiece 192 is received in a front end of the sleeve 180 and is retained on the sleeve 180 and the chuck body 122 by a C-ring 194. The nosepiece 192 may be rotatable relative to the sleeve 180 or may be configured to rotate together with the sleeve 180.

Referring also to FIGS. 13A-13D, when assembled, the bottom clamping surface 148 of the top jaw portion 142 abuts the top clamping surface 150 of the bottom jaw portion 144 together define a first clamping interface 181 that is disposed at a first acute angle ?1 to the longitudinal axis X (e.g., approximately 30° to approximately 60°). The inner clamping surface 172 of the clamping ring 170 abuts the top clamping surface 146 of the first jaw portion 142 to define a second clamping interface 175 that is disposed at a second acute angle ?2 to a line L that is parallel to the longitudinal axis X (e.g., approximately 1° to approximately 15°) that is less than the first acute angle ?1.

In operation, the chuck 120 is actuatable to clamp or release the tool bit 105 between the jaw assemblies 140 when there is relative movement between the clamping ring 170 and outer sleeve 180, on the one hand, and the chuck body 122, on the other hand. Such relative motion can be achieved by holding the outer sleeve 180 and clamping ring 170 rotationally stationary (e.g., by a user grasping the outer sleeve 180 to prevent rotation or by locking the outer sleeve 180 to the tool housing 112, as described above with respect to FIGS. 7A-7B), while actuating the motor to rotate the output spindle of the power tool and the chuck body 122. Alternatively, the output spindle can be coupled to a spindle lock which prevents backdriving of the output spindle when a torque is applied to the chuck 120 by a user. In this manner the chuck body 122 remains rotationally stationary while a user rotates the outer sleeve 180 and clamping ring 170 to clamp or release a tool bit between the jaw assemblies 180.

The clamping of the tool bit 105 between the jaw assemblies 140 occurs in two phases. Referring to FIG. 13C, during a first clamping phase, as the outer sleeve 180 rotates relative to the chuck body 120, the detent 174 on the inner clamping ring 171 remains secured in one of the recesses 169 in the outer clamping ring 173 so that the inner clamping ring 171 and the outer clamping ring 173 rotate as a unit relative to the chuck body 122. This rotation of the inner clamping ring 171 and outer clamping ring 173 causes them move axially as a unit rearward in a direction C′ that is generally parallel to the longitudinal axis X. At the same time the inner clamping surface 172 of the outer clamping ring 173 remains frictionally engaged with the top clamping surface 146 on the first jaw portion 142, while the bottom clamping surface 148 of the first jaw portion 142 slides along the top clamping surface 150 of the second jaw portion 144 (i.e., along the first interface 181) in a direction D′. This is because the second clamping interface 175 is orientated at a smaller angle relative to the longitudinal axis X than the first clamping interface 181. The movement of the top jaw portion 142 in the direction D′ pushes the first jaw portion 144 radially inward in a direction E′ that is transverse (e.g., orthogonal) to the longitudinal axis X against the force of the spring. The bottom jaw portion 144 moves radially inward so that its bottom clamping surface 151 clamps the tool bit 105 with a first clamping force up to a maximum first clamping force.

Referring to FIG. 13D, once the bottom clamping surface 151 of the bottom jaw portion 144 clamps the tool bit 105 with the maximum first clamping force, the second clamping phase begins. As the outer sleeve 180 continues to rotate, the detent 174 slips out of the recess 169, allowing the outer clamping ring 173 to rotate relative to the inner clamping ring 171. At the same time, the friction force between the bottom clamping surface 148 of the first jaw portion 142 and the top clamping surface 150 of the second jaw portion 144 (i.e., the first clamping interface 181) exceeds the friction force between top clamping surface 146 of the first jaw portion 142 and the clamping surface 172 of the outer clamping ring 171 (i.e., the second clamping interface 175). This causes the relative motion first jaw portion 142 and the second jaw portion 144 along the first clamping interface 181 to stop, which also causes the axial movement of the inner clamping ring 171 to stop. Instead, the outer clamping ring 173 will rotate and translate relative to the inner clamping ring 171 in the axial direction C′ that is generally parallel to the longitudinal axis. At the same time, there is relative motion between the inner clamping surface 172 of the outer clamping ring 173 and the top clamping surface 146 of the first jaw portion 142 along the second clamping interface 175 in a direction F′ parallel to the second angle ?2. This causes the first jaw portion 142 and the second jaw portion 144 to move in unison in the direction E′ that is transverse (e.g., orthogonal) to the longitudinal axis X. This causes the second jaw portion 144 and, thus the jaw assembly 140, to clamp the tool bit 105 at a second clamping force that is greater than the maximum first clamping force. This movement will continue until the force acting on the second clamping interface 175 becomes too great for torque being inputted to continue rotating and translating the outer clamping ring 173. Thus, the combination of initial tightening along the first clamping interface 173 to a first maximum force and further tightening along the second clamping interface 175 to a force that is greater than the first maximum force provides enhanced holding force on the tool bit in a compact assembly.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

Example embodiments have been provided so that this disclosure will be thorough, and to fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. Numerous modifications may be made to the exemplary implementations described above. These and other implementations are within the scope of this patent application.

What is claimed is:

1. A power tool chuck comprising:
a chuck body extending along a chuck axis and couplable to an output spindle of a rotary power tool;
a longitudinal bore defined in the body along the axis for receiving a tool bit therein;
a plurality of radial slots defined in the body in communication with the longitudinal bore;
a plurality of jaw assemblies received in the body, each jaw assembly at least partially received in one of the plurality of radial slots and moveable to engage and removably retain the tool bit in the chuck body;
a clamping ring received over the chuck body and the jaw assemblies and rotatable relative to the chuck body and the jaw assemblies to engage and removably retain the tool bit in the chuck body,
wherein the clamping ring and each jaw assembly together define a first clamping interface configured to cause the jaw assembly to clamp the tool bit a first clamping force up to a first maximum clamping force during a first phase of clamping, and a second clamping interface configured to cause the jaw assembly to clamp the tool bit at a second clamping force that is greater than the first maximum clamping force during a second phase of clamping.

2. The chuck of claim 1, wherein the first clamping interface is oriented at a first angle relative to the axis and the second clamping interface is oriented at a second angle relative to the axis that is less than the first angle.

3. The chuck of claim 1, wherein each jaw assembly comprises a first jaw portion and a second jaw portion.

4. The chuck of claim 3, wherein the first clamping interface is defined between the first jaw portion and the clamping ring, and the second clamping interface is defined between the first jaw portion and the second jaw portion.

5. The chuck of claim 4, wherein the first clamping interface is oriented at a first angle relative to the axis and the second clamping interface is oriented at a second angle relative to the axis that is less than the first angle.

6. The chuck of claim 3, wherein the first clamping interface is defined between the first jaw portion and the second jaw portion, and the second clamping interface is defined between the first jaw portion and the clamping ring.

7. The chuck of claim 6, wherein the first clamping interface is oriented at a first angle relative to the axis and the second clamping interface is oriented at a second angle relative to the axis that is less than the first angle.

8. The chuck of claim 1 and wherein the clamping ring is threadably connected to the chuck body.

9. The chuck of claim 1, further comprising an outer sleeve received over the clamping ring so that the outer sleeve and clamping ring rotate together.

10. The chuck of claim 9, wherein relative rotation between the clamping ring and the chuck body causes the jaw assembly to clamp the tool bit at the first clamping force and the second clamping force.

11. The chuck of claim 1, wherein the jaw assembly is biased away from clamping the tool bit by at least one spring.

12. The chuck of claim 11, wherein the at least one spring comprises a first spring biasing the jaw assembly away from the chuck body in a direction substantially transverse to the axis.

13. The chuck of claim 12, wherein the at least one spring further comprises a second spring biasing the jaw assembly in a direction substantially parallel to the axis.

14. A power tool chuck comprising:
a chuck body extending along a chuck axis and couplable to an output spindle of a rotary power tool;
a longitudinal bore defined in the body along the axis for receiving a tool bit therein;
a plurality of radial slots defined in the body in communication with the longitudinal bore;
a plurality of jaw assemblies received in the body, each jaw assembly at least partially received in one of the plurality of radial slots and moveable to engage and removably retain the tool bit in the chuck body;
a clamping ring received over the chuck body and the jaw assemblies and rotatable relative to the chuck body and the jaw assemblies to engage and removably retain the tool bit in the chuck body,
wherein each jaw assembly defines a first jaw portion and a second jaw portion moveable relative to the first jaw portion, and one of the first jaw portion and the second jaw portion is configured to cause the jaw assembly to clamp the tool bit at a first clamping force up to a first maximum clamping force during a first phase of clamping, and the other of the first jaw portion and the second jaw portion is configured to cause the jaw assembly to clamp the tool bit at a second clamping force that is greater than the first maximum clamping force during a second phase of clamping.

15. The chuck of claim 14, wherein the jaw assembly has a first clamping interface oriented at a first angle relative to the axis and the second clamping interface oriented at a second angle relative to the axis that is less than the first angle.

16. The chuck of claim 15, wherein the first jaw portion directly engages the clamping ring and the second jaw portion, and the second jaw portion directly engages the first jaw portion and the tool bit.

17. The chuck of claim 16, wherein the first clamping interface is defined between the first jaw portion and the clamping ring and the second clamping interface is defined between the second jaw portion and the first jaw portion.

18. The chuck of claim 16, wherein the first clamping interface is defined between the first jaw portion and the second jaw portion and the second clamping interface is defined between the first jaw portion and the clamping ring.

19. The chuck of claim 14, wherein the jaw assembly is biased away from clamping the tool bit by at least one spring.

20. A power tool chuck comprising:
a chuck body extending along a chuck axis and couplable to an output spindle of a rotary power tool;
a longitudinal bore defined in the body along the axis for receiving a tool bit therein;
a plurality of radial slots defined in the body in communication with the longitudinal bore;
a plurality of jaw assemblies received in the body, each jaw assembly at least partially received in one of the plurality of radial slots and moveable to engage and removably retain the tool bit in the chuck body;
a clamping ring received over the chuck body and the jaw assemblies and rotatable relative to the chuck body and the jaw assemblies to engage and removably retain the tool bit in the chuck body, wherein the clamping ring comprises an inner ring threadably connected to the chuck body by a first thread and an outer ring received over and threadably connected to the inner ring by a second thread, the first thread configured to cause the jaw assembly to clamp the tool bit a first clamping force up to a first maximum clamping force when the inner ring rotates relative to the chuck body during a first phase of clamping, and the second thread is configured to cause the jaw assembly to clamp the tool bit at a second clamping force that is greater than the first maximum clamping force when the outer ring rotates relative to the inner ring and the chuck body during a second phase of clamping.
